(19) United States
(12) Patent Application Publication
(10) Pub. No.: US 2026/0081777 A1
(43) Pub. Date: Mar. 19, 2026

(54) Binomial Sampling in Lattice-Based Cryptography

(71) Applicant: Infineon Technologies AG, Neubiberg (DE)

(72) Inventor: Tim Fritzmann, Kissing (DE)

(21) Appl. No.: 19/329,108

(22) Filed: Sep. 15, 2025

(30) Foreign Application Priority Data
Sep. 16, 2024 (DE) 102024208822.6

(51) Int. Cl. H04L 9/30; H04L 9/00

(52) U.S. Cl. CPC H04L 9/3093; H04L 9/002; H04L 2209/08

(57) ABSTRACT

Solutions described herein refer to a lattice-based cryptographic operation, comprising a binomial sampling of coefficients, wherein a randomized expansion of binomial sampling operands utilize a value e.

### TECHNICAL FIELD

This disclosure is related to cryptographic circuitry, and more particularly to lattice-based cryptography in such circuits.

### BACKGROUND

Binomial sampling is one of the core operations of lattice-based cryptography. It is used to generate the secret and error polynomials required to create the Learning With Errors (LWE) problem. As a prominent example, the sampling is also used in the so-called ML-KEM algorithm, which has been selected as a future standard for Key Encapsulation Mechanisms (KEM) by the National Institute of Standards and Technology (NIST). The secure implementation of the binomial sampling is of utmost relevance in order to protect the secret keys.

The binomial sampling is a non-linear function, which is difficult to protect against implementation attacks such as Side-Channel Attacks (SCA) and fault attacks. In addition, the re-encryption of the Fujisaki Okamoto transform (Eiichiro Fujisaki and Tatsuaki Okamoto. “Secure integration of asymmetric and symmetric encryption schemes,” in Annual international cryptology conference, pages 537-554. Springer, 1999, and Eiichiro Fujisaki and Tatsuaki Okamoto, “Secure integration of asymmetric and symmetric encryption schemes,” Journal of Cryptology, 26:80-101, 2013) adds a significant vulnerability to the ML-KEM algorithm. It allows the mounting of powerful side-channel assisted Chosen-Ciphertext Attacks (CCA), as illustrated in Prasanna Ravi, Sujoy Sinha Roy, Anupam Chattopadhyay, and Shivam Bhasin, “Generic side-channel attacks on CCA-secure lattice-based PIKE and KEM scheme,” Cryptology ePrint Archive, 2019.

For this reason, all re-encryption components, including the binomial sampling, need to be subject to special protection. Scientists agree that simple first-order masking, which randomly splits secret components into two shares, is not sufficient. For example, in Melissa Azouaoui, Joppe W. Bos, Bjorn Fay, Marc Gourjon, Yulia Kuzovkova, Joost Renes, Tobias Schneider, and Christine van Vredendaal, “Surviving the FO-CALYPSE: Securing PQC implementations in practice,” Real World Cryptography, 2022, higher-order masking is suggested to protect against powerful attacks. However, using higher-order masking is extremely expensive, computationally. In Joppe Willem Bos, Marc Olivier Gourjon, Joost Renes, Tobias Schneider, and Christine van Vredendaal, “Masking Kyber: First- and higher-order implementations,” IACR Transactions on Cryptographic Hardware and Embedded Systems, 2021(4): 173-214, 2021, an execution time overhead of 3.5× (two shares), 50× (three shares) and 131× (four shares) is determined for the ML-KEM decapsulation.

Another disadvantage of higher-order masking is the high amount of memory required.

Complex approaches to increase the level of protection usually have the disadvantages that they result in an increase in chip area and/or an increased amount of processing efforts leading to hardware with more processing power and higher power consumption.

### SUMMARY

Hence, it is an objective of various embodiments described herein to protect binomial sampling against attacks on cryptographic operations in a cryptographic circuit and/or limit the efforts, e.g., computational costs, involved. This is solved according to the features of the independent claims. Further embodiments result from the depending claims.

The examples suggested herein may in particular be based on at least one of the following solutions. Combinations of the following features may be utilized to reach a desired result. The features of the method could be combined with any feature(s) of the device, apparatus or system or vice versa.

A device for processing a lattice-based cryptographic operation is disclosed,
comprising a processing unit that is arranged to conduct a binomial sampling of coefficients comprising conducting a randomized expansion of binomial sampling operands utilizing a value e.

It is noted that the value e may be a vector of values.

It is noted that “random” or “randomized” used in the context of this application may in particular refer to true randomness, pseudo randomness or even to some deterministic approach that may introduce a sufficient level of entropy. The random generator mentioned herein may in particular provide a predefined level of entropy.

According to an embodiment, the value e is a random value ranging from zero up to 2^{θ}−1, wherein θ is an expansion parameter.

According to an embodiment, conducting the randomized expansion further comprises:
creating a random value f with the same Hamming weight as the value e, wherein γ is the number of bits of the random value f,
extending a first operand x of the binomial sampling operands to a value x′=x∥e and a second operand y of the binomial sampling operands to a value y′=y∥f, wherein the value x′ comprises η+θ bits and the value y′ comprises η+γ bits.

According to an embodiment, the processing unit is further arranged to perform a critical computation of the binomial sampling with the values x′ and y′.

It is noted that the critical computation (comprising at least one critical operation) is the computation that is to be protected from side-channel attacks or fault attacks.

According to an embodiment, the random value f equals the value e.

According to an embodiment, bit positions of the value x′ and/or bit positions of the value y′ are randomized.

According to an embodiment, conducting the randomized expansion further comprises:
creating the value e as a random value with a Hamming weight wₑ, wherein θ is the number of bits of the random value e,
creating a random value f with a Hamming weight w_{f}, wherein γ is the number of bits of the random value f,
extending a first operand x of the binomial sampling operands to a value x′=x∥e and a second operand y of the binomial sampling operands to y′=y∥f, wherein the value x′ comprises η+θ bits and the value y′ comprises η+γ bits.

According to an embodiment, the processing unit is further arranged to perform a critical computation of the binomial sampling with the values x′ and y′.

According to an embodiment, an offset is added to the result of the critical computation.

According to an embodiment, the offset amounts to w_{f}−wₑ.

According to an embodiment, bit positions of the value x′ and/or bit positions of the value y′ are randomized.

According to an embodiment, the randomized expansion is embedded within a bit-slicing transformation and a reverse bit-slicing transformation.

According to an embodiment, the device is at least one of the following or it is part of at least one of the following:
a security device,
a secured cloud,
a secured service,
an integrated circuit,
a hardware security module,
a trusted platform module,
a crypto unit,
an FPGA,
a processing unit,
a controller,
a smartcard.

Another example refers to a method for processing a lattice-based cryptographic operation, the method comprising:
conducting a binomial sampling of coefficients, wherein a randomized expansion of binomial sampling operands is conducted utilizing a value e.

According to an embodiment, the value e is a random value ranging from zero up to 2^{θ}−1, wherein θ is an expansion parameter.

According to an embodiment, the randomized expansion of binomial sampling operands further comprises:
creating a random value f with the same Hamming weight as the value e, wherein γ is the number of bits of the random value f,
extending a first operand x of the binomial sampling operands to a value x′=x∥e and a second operand y of the binomial sampling operands to a value y′=y∥f, wherein the value x′ comprises η+θ bits and the value y′ comprises η+γ bits.

According to an embodiment, a critical computation of the binomial sampling is conducted utilizing the values x′ and y′.

According to an embodiment, the random value f equals the value e.

According to an embodiment, bit positions of the value x′ and/or bit positions of the value y′ are randomized.

According to an embodiment, the randomized expansion of binomial sampling operands further comprises:
creating the value e as a random value with a Hamming weight wₑ, wherein θ is the number of bits of the random value e,
creating a random value f with a Hamming weight w_{f}, wherein γ is the number of bits of the random value f,
extending a first operand x of the binomial sampling operands to a value x′=x∥e and a second operand y of the binomial sampling operands to y′=y∥f, wherein the value x′ comprises η+θ bits and the value y′ comprises η+γ bits.

According to an embodiment, a critical computation of the binomial sampling is conducted utilizing the values x′ and y′.

According to an embodiment, an offset is added to the result of the critical computation.

According to an embodiment, the offset amounts to w_{f}−wₑ.

According to an embodiment, bit positions of the value x′ and/or bit positions of the value y′ are randomized.

According to an embodiment, the randomized expansion is embedded within a bit-slicing transformation and a reverse bit-slicing transformation.

### BRIEF DESCRIPTION OF THE FIGURES

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows an exemplary notation of an Algorithm 1 implementing a function SamplePolyVec;

FIG. 2 shows an exemplary notation of an Algorithm 2 implementing a function SecSampling;

FIG. 3 shows an exemplary notation of an Algorithm 3 implementing a function BitSliceSampling;

FIG. 4 shows an exemplary notation of an Algorithm 6 implementing a function BitAddTree;

FIG. 5 shows an exemplary notation of an Algorithm 4 implementing a function RevBitSliceSampling;

FIG. 6 shows an exemplary notation of an Algorithm 5 implementing a function BitAdd;

FIG. 7 shows an exemplary flow diagram visualizing the process of sampling countermeasures;

FIG. 8 shows an exemplary notation of an Algorithm 7 implementing a function SecMaskedSampling;

FIG. 9 shows an exemplary arrangement of a processing device comprising a CPU, a RAM, a non-volatile memory, a crypto module, an analog module, an input/output interface and a hardware-random number generator;

FIG. 10 shows an alternative arrangement with a hardware security module (HSM);

FIG. 11 shows an exemplary diagram illustrating a bit-slicing example;

FIG. 12 shows a block diagram of a lattice-based crypto core.

### DETAILED DESCRIPTION

Examples described herein show efficient low-cost countermeasures that can be integrated into a binomial sampling operation performed in a cryptographic processing circuit to prevent powerful attacks on the circuit, e.g., side-channel attacks or fault attacks, from being successful.

In particular, characteristics of the binomial sampling process are used to introduce randomizations, to obfuscate the computations. This comprises, e.g., shuffling at different levels and random modifications of the secret operands of the sampling process. Shuffling in particular refers to a randomized execution order of (selected or all) operations in the time domain.

Herein, the subscript i of xᵢ denotes the i-th bit of the variable x. The access of multiple bits from i to j is indicated by x_{{i:j}}. Accessing the i-th vector element of a variable x is written as x[i]. The superscript is used to access different masking shares, e.g., x^{{i:j}} accesses shares i to j. Sampling a random element x in [0, q−1] from a uniform distribution is denoted as x [symbol] [symbol] _{q}.

### Binomial Sampling and Bit-Slicing

In the following paragraphs, the binomial sampling and its application to lattice-based cryptography are described.

### Definition of Binomial Sampling

x, y are two uniformly distributed integers in [0, 2^{η}−1]. The centered binomial sampling is defined as the subtraction of the Hamming Weights (HW) of x and y leading to the following equation

$$SampleCoeff ( x , y ) = {ψ}_{η} ( x , y ) = HW ( x ) - HW ( y ) mod q , \qquad ( 1 )$$

wherein q is a prime integer and η is a binomial distribution parameter. Equation (1) can be reformulated as

$$SampleCoeff ( x , y ) = {\sum }_{i = 0}^{η - 1} ( {x}_{i} - {y}_{i} ) mod q , \qquad ( 2 )$$

wherein the subscripts xᵢ and yᵢ denote the bitwise access of the two integers.

### Application in Lattice-Based Cryptography

Most modern lattice-based cryptography algorithms sample vectors of polynomials in the ring

$${ℛ}_{q}^{k} = {Z}_{q}^{k} / 〈 {x}^{n} + 1 〉$$

with vector dimension k and polynomial length n.

The binomial sampling is applied in lattice-based cryptography for each of the n coefficients aᵢ of a polynomial a=a₀+a₁x+a₂x²+ . . . +aₙ₋₁xⁿ⁻¹ individually.

The uniform randomness required for the two uniformly distributed integers x and y during the sampling of each coefficient can be extracted from a Pseudo-Random Number Generator (PRNG) bit stream, which is typically generated with a secure hash algorithm (e.g., SHAKE-256 in ML-KEM).

### Bit-Slicing

Equation (1) requires summing up the individual bits of the input operands. However, bit extractions and operations on single bits are extremely inefficient on wordoriented processors.

Bit-slicing was introduced in Tobias Schneider; Clara Paglialonga, Tobias Oder, and Tim Giineysu, “Efficiently masking binomial sampling at arbitrary orders for lattice-based crypto,” in Public-Key Cryptography-PKC 2019: 22nd IACR International Conference on Practice and Theory of Public-Key Cryptography, Beijing, China, Apr. 14-17, 2019, Proceedings, Part II 22, pages 534-564. Springer, 2019, and Michiel Van Beirendonck, Jan-Pieter D'anvers, Angshuman Karmakar, Josep Balasch, and Ingrid Verbauwhedem, “A side-channel-resistant implementation of SABER,” ACM Journal on Emerging Technologies in Computing Systems (JETC), 17(2): 1-26, 2021, to accelerate the performance of these bit operations. It allows processing 32 coefficients in parallel on a 32-bit architecture. The sampling in bit-sliced domain requires a conversion into bit-sliced domain (here denoted as BitSlice) and a reverse operation at the end (here denoted as RevBitSlice).

### Efficient Obfuscation Against Attacks

The next paragraphs illustrate low-cost randomization examples to hide the relation between the power consumption and the processed data.

### Shuffling on Polynomial and Coefficient Level

Shuffling is an effective countermeasure against all types of side-channel attack (SCA), which, in contrast to masking, usually does not require more memory. The effectiveness of the shuffling approach is increased by the number of positions which are shuffled or swapped.

Shuffling at the sampling process can be performed on several levels:
Shuffle between all k polynomials in a vector of polynomials.
Shuffle between all n coefficients is not possible due to bit-slicing. A group has 32 coefficients (for 32-bit processors) and shuffling can be done between these groups.

Shuffling algorithms, such as the Fisher Yates algorithm (Ronald Aylmer Fisher, Frank Yates, et al., Statistical tables for biological, agricultural and medical research, Edinburgh: Oliver and Boyd, 1963), can be used for this purpose. In Zhaohui Chen, Yuan Ma, and Jiwu Jing, “Low-cost shuffling countermeasures against side-channel attacks for NTT-based post-quantum cryptography,” IEEE Transactions on Computer-Aided Design of Integrated Circuits and Systems, 42(1): 322-326, 2022, a basic form of shuffling is described for steps of the polynomial multiplication.

Shuffling efficiently adds noise for the attacker, but it may (due to the bit-slicing) not be fine-grained enough to effectively protect against sophisticated attacks. Therefore, improvements of randomization are proposed herein.

### Shuffling of Bit Positions

Equation (1) can be reformulated as

$$SampleCoeff ( x , y ) = {\sum }_{i = 0}^{η - 1} {x}_{i} - {\sum }_{j = 0}^{η - 1} {y}_{j} mod q = {\sum }_{i = 0}^{η - 1} {x}_{ShuffleIndex ( i )} - {\sum }_{j = 0}^{η - 1} {y}_{ShuffleIndex ( j )} mod q . \qquad ( 3 )$$

Usually, this summation happens in the order

$$i = 0 , 1 , … , η - 1$$

$$or$$

$$j = 0 , 1 , … , η - 1 .$$

However, the hardware computation tolerates a different summation order and shuffling can be applied during this computation (based on the commutative law). In particular, bit-slicing can be used to implement such swap.

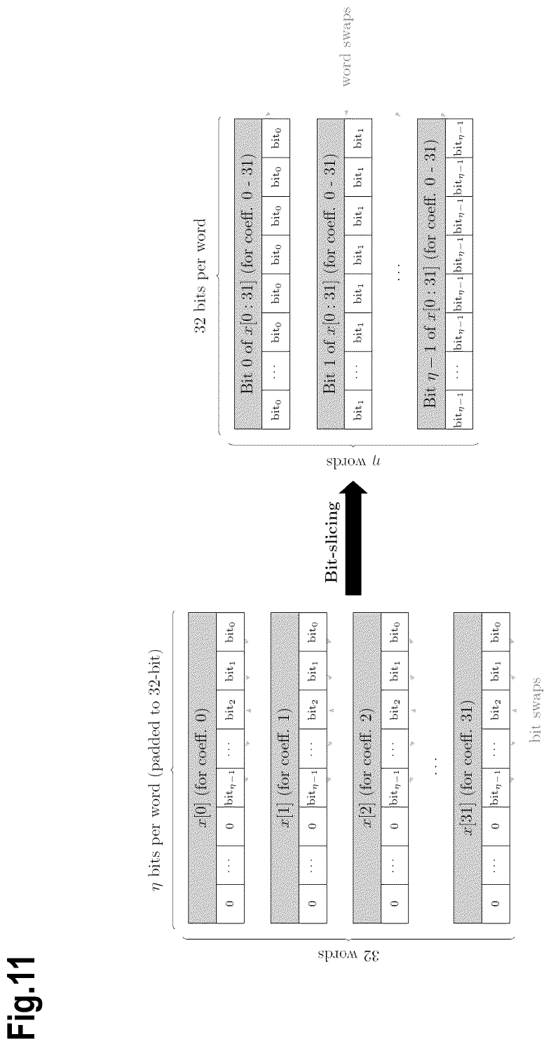

FIG. 11 shows an exemplary diagram illustrating a bit-slicing example. On the left hand side, 32 words x[0] to x[31] are shown, each such word comprising a total length of 32 bits. However, in this example, in each of the 32 words x[0] to x[31], only a number of η bits are used (η<32) and each of the remaining (32−η) bits is padded with the value 0. Hence, a total number of 32·(32−η) bits contain the value 0, which here equals no information.

The bit-slicing transformation results in the information as shown on the right hand side: The η bits of the 32 words x[0] to x[31] are combined to η words each comprising 32 bits, i.e., each of the 32 columns of the words x[0] to x[31] results in a 32-bit word combining the respective first, second, etc. η bits. Hence, the values 0 of the original representation are omitted resulting in a total number of n·32 bits.

With regard to the representation before the bit-slicing transformation (i.e., left hand side of FIG. 11), bit swaps between y bits can be applied to all of the 32 words x[0] to x[31]. After the bit-slicing transformation, the swapping can be applied between η words to realize a bit swapping. This is more efficient compared to the swapping of single bits.

### Random Expansion of Operands

It is assumed that e is a random variable of 0 bits that is integrated to expand the operands x and y. The expansion increases the operand size from η bits to η+0.

This can be a concatenation defined as

$${x}^{′} = x ⊕ ( e ≪ η )$$

$$and$$

$${y}^{′} = y ⊕ ( e ≪ η ) .$$

The expansion is particularly powerful for small values of η (as for ML-KEM 512 where η=2) to significantly increase the search space for an attacker.

It is noted that ‘⊕’ refers to an exclusive-or operation.

Combined with the shuffling approach at the Hamming weight computations, the binomial sampling can be expressed as

$$SampleCoeff ( x , y ) = {\sum }_{i = 0}^{η - 1} {x}_{ShuffleIndex ( i )} - {\sum }_{j = 0}^{η - 1} {y}_{ShuffleIndex ( j )} mod q = {\sum }_{i = 0}^{η + θ - 1} {x}_{ShuffleIndex ( i )}^{′} - {\sum }_{j = 0}^{η + θ - 1} {y}_{ShuffleIndex ( j )}^{′} mod q . \qquad ( 4 )$$

### Random Swap of Operands

It is assumed that s is a random bit that determines whether swapping occurs (s=1) or swapping does not occur (s=0).

In addition to swapping the bit positions of x and y, the order of the computations for the subtraction can be swapped as shown in the following equation

$$SampleCoeff ( x , y ) = {\sum }_{i = 0}^{η - 1} {x}_{i} - {\sum }_{i = 0}^{η - 1} {y}_{j} mod q = - {\sum }_{i = 0}^{η - 1} {y}_{i} - {\sum }_{i = 0}^{η - 1} {x}_{j} mod q = {( - 1 )}^{s} {{\sum }^{η - 1}}_{i = 0} ( {x}_{i} \& NOT ( s ) ) ⊕ ( {y}_{i} \& s ) + {( - 1 )}^{NOT ( s} {{\sum }^{η - 1}}_{j = 0} ( {x}_{i} \& s ) ⊕ ( {x}_{j} \& NOT ( s ) ) mod q . \qquad ( 5 )$$

Therefore, the order whether HW(x) or HW(y) is computed first can be swapped randomly.

As subtracting the number of bits set to 1 is the same as adding the bits set to 0 minus the total number of bits, i.e., utilizing the property

$$HW ( x ) - HW ( y ) = HW ( x ) + HW ( NOT ( y ) ) - η$$

leads to

$$SampleCoeff ( x , y ) + η = {{\sum }^{η - 1}}_{i = 0} ( {x}_{i} \& NOT ( s ) ) ⊕ ( {y}_{i} \& s ) ⊕ s + {{\sum }^{η - 1}}_{j = 0} ( {x}_{i} \& s ) ⊕ ( {x}_{j} \& NOT ( s ) ) ⊕ NOT ( s ) mod q . \qquad ( 6 )$$

### Random Rotation of Coefficients in Bit-Sliced Domain

In a bit-sliced domain, Equation (3) processes 32 coefficients in parallel

$$BitSlice ( poly [ 0 : 31 ] ) = {{\sum }^{η - 1}}_{i = 0} {x [ i ]}_{\{ 0 : 31 \}} - {{\sum }^{η - 1}}_{j = 0} {y [ i ]}_{\{ 0 : 31 \}} mod q . \qquad ( 7 )$$

If r is a random integer in [0,31] that determines a rotation (ROR) of the 32 coefficients, the computation of the coefficients can be performed in rotated fashion according to the following equation

$$( 8 )$$

$$BitSlice ( {poly}^{′} [ 0 : 31 ] ) = {{\sum }^{η - 1}}_{i = 0} ROR ( {x [ i ]}_{\{ 0 : 31 \}} , r ) - {{\sum }^{η - 1}}_{j = 0} ROR ( {x [ j ]}_{\{ 0 : 31 \}} , r ) mod q ,$$

wherein the coefficients of poly′[0:31] are rotated by r. After the critical non-linear HW computation, the rotation can be reverted.

### Exemplary Implementation

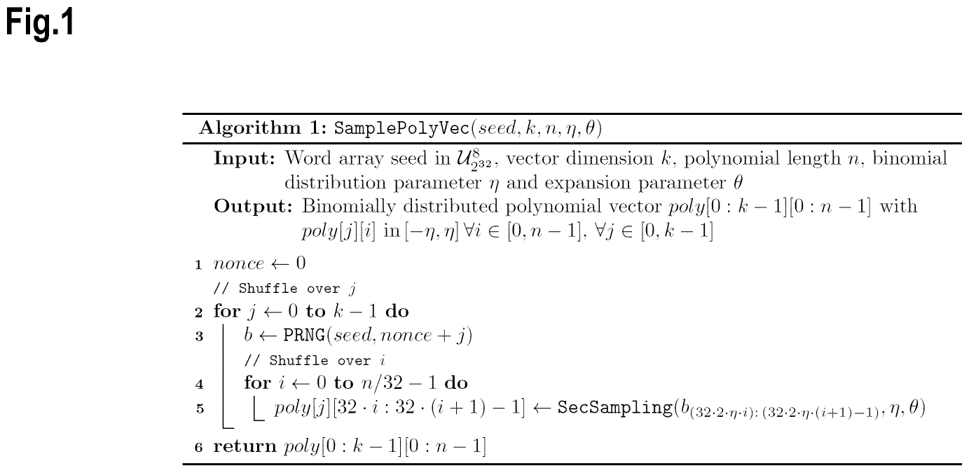

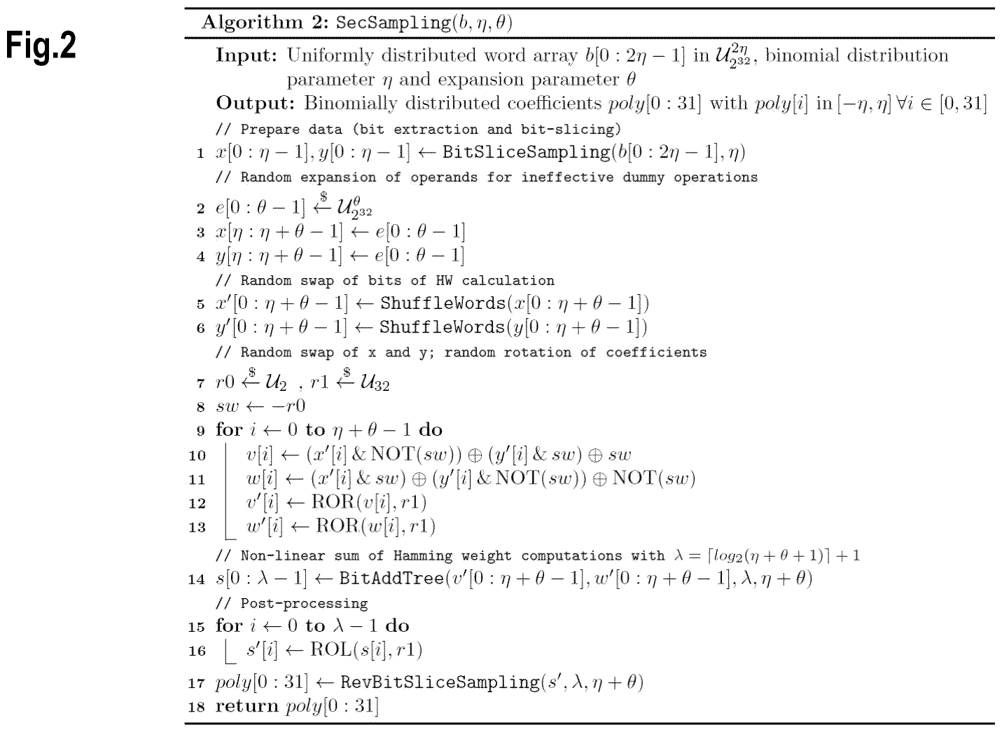

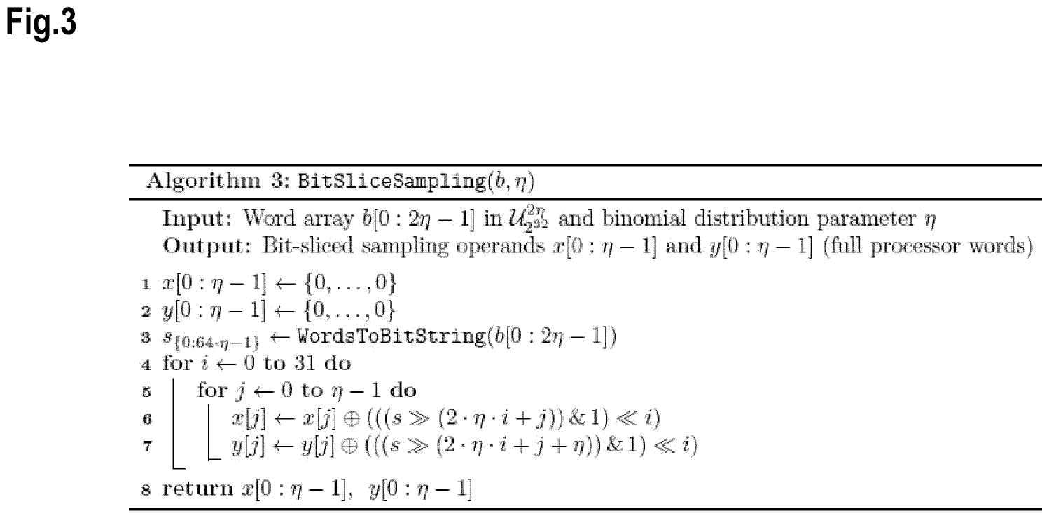

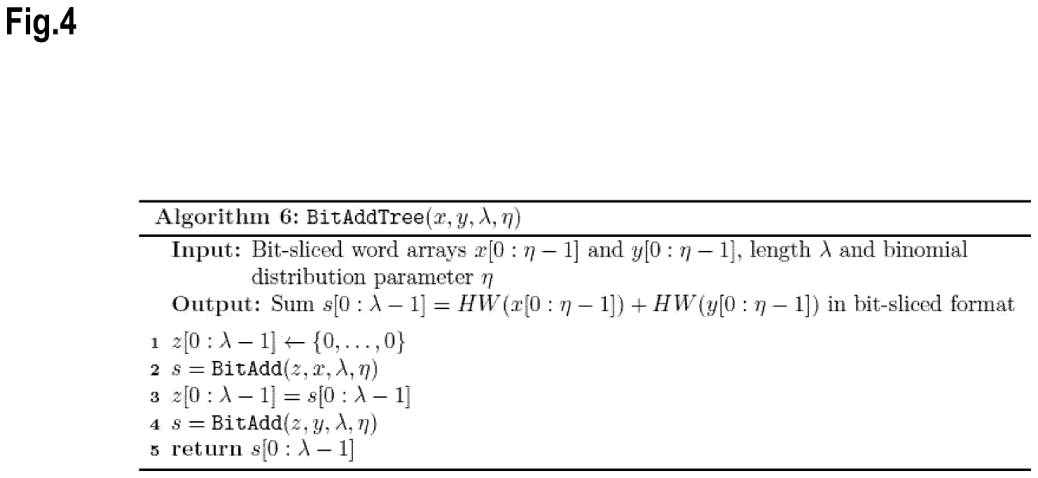

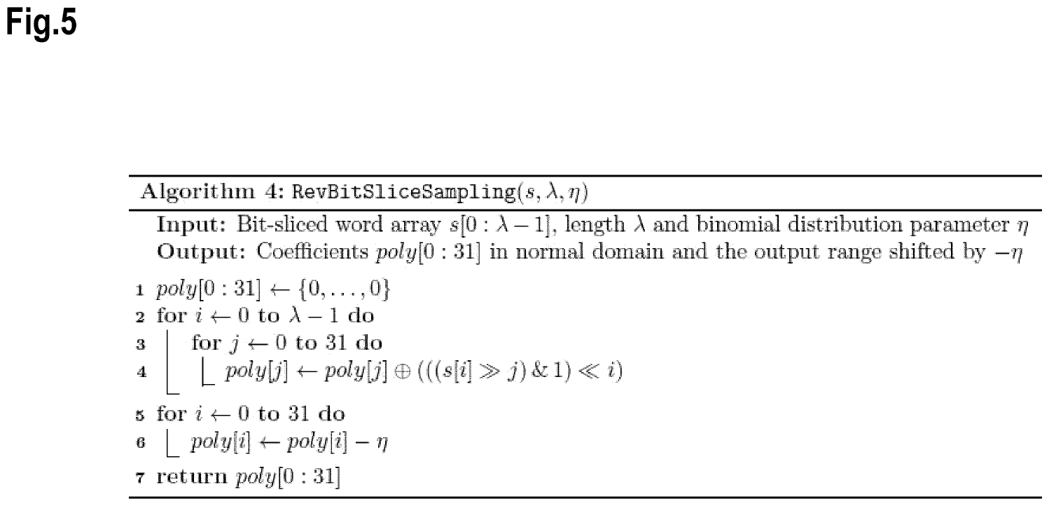

FIG. 1 to FIG. 6 each shows exemplary algorithms or functions. FIG. 1 comprises an Algorithm 1, which supplies a sampled binomially distributed polynomial vector. Algorithm 1 uses a function SecSampling, which is shown as an Algorithm 2 in FIG. 2. Algorithm 2 uses several functions:
a function BitSliceSampling illustrated as an Algorithm 3 in FIG. 3,
a function BitAddTree illustrated as an Algorithm 6 in FIG. 4, and
a function RevBitSliceSampling illustrated as an Algorithm 4 in FIG. 5.

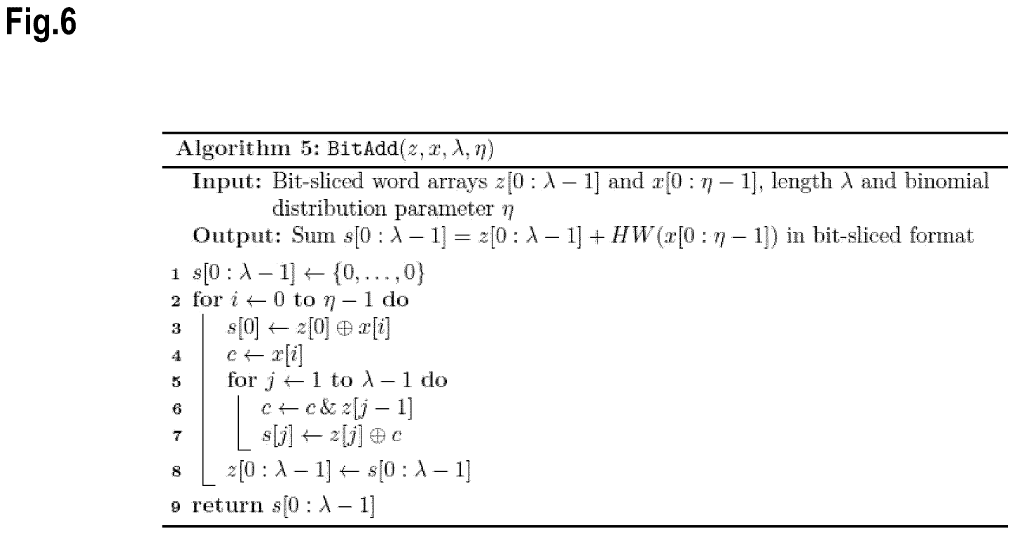

Algorithm 6 uses a function BitAdd, which is shown as an Algorithm 5 in FIG. 6.

The function PRNG in Algorithm 1 generates random bytes for the sampling of one polynomial based on a seed and a cryptographic nonce as input.

The function ShuffleWords in Algorithm 2 randomly swaps the words (in particular all words) of a vector of words that is provided as input.

The function WordsToBitString in Algorithm 3 obtains a vector of words as input and transforms it into a bit-string.

Algorithm 3 is used to extract the operands for the sampling process and to convert them directly into the bit-sliced domain. Algorithm 4 transforms the output from the bit-sliced back into the normal domain.

Algorithms 5 and 6 perform the non-linear Hamming weight computations. Before entering this computation step, the input operands are randomized using the proposed methods. Typically, the bit summations are done with a secure adder tree (here denoted as BitAddTree). This tree consists of adders built with linear XOR and non-linear AND operations. It can be efficiently integrated with one or two shares.

Higher-order masked AND operations are possible but become increasingly expensive with an increasing number of shares. Algorithm 5 follows the principles of [SPOG19, BDK⁺21].

Boolean/Arithmetic masking: Secret information can be processed in randomized shares to prevent side-channel leakages (e.g., with power or electromagnetic sidechannels). Processing secret information on randomized shares avoids a correlation between the secret data and, e.g., the current power consumption. Typically, a secret variable x is randomly split using a Boolean sharing (e.g., x=x⁰⊕x¹) or an arithmetic sharing (e.g., x=x⁰+x¹).

FIG. 1, Algorithm 1: Algorithm 1 is the top-level algorithm for the generation of a binomially distributed polynomial vector. It takes as input a 32-byte seed (i.e., 8 words), the polynomial vector dimension k, the polynomial length n, the binomial distribution parameter n and the expansion parameter θ. In line 1, the nonce, i.e., a value that is only used once in each iteration, is initialized. In line 3, the bit string b is generated calling the function PRNG for each of the k polynomials. The function PRNG takes as input the seed and the nonce, wherein the latter is incremented by a loop counter j. Hence, the concatenation of the seed and the incremented nonce value is different for each call of the function PRNG. The bit string b is then split in line 5 into n/32 pieces, i.e., chunks, wherein each chunk is used to generate w=32 coefficients of the i-th polynomial (poly[i][0:n−1]) using the function SecSampling. It is noted that the bit string of the function PRNG is handed over as a word array to the function SecSampling. The loop counters of the inner and outer loop can be shuffled to randomize the execution order. The output polynomial vector is returned in line 6.

FIG. 2, Algorithm 2: Algorithm 2 is the algorithm conducting the secure sampling of w binomially distributed coefficients. It takes as input the word array b[0:2η−1] generated using the function PRNG and the parameters η and θ. The algorithm consists of four parts: pre-processing, applying countermeasures, executing critical non-linear operation and post-processing.

In the pre-processing stage (line 1), Algorithm 2 forwards the uniformly distributed word array b[0:2η−1] to the Algorithm 3 BitSliceSampling in order to extract the operands for the non-linear part of the binomial sampling. In addition to the operand extraction, the Algorithm 3 BitSliceSampling transforms the operands into the bit-sliced domain. This allows operating on full processor words for further operations. The operands x[0:η−1] and y[0:η−1] are the output of this pre-processing stage.

In the next stage (lines 2 to 13), Algorithm 2 integrates all countermeasures to prepare the operands for the critical operations. In lines 2 to 4, an expansion of the operands x[0:η−1] and y[0:η−1] with a random vector e [0: θ−1] is conducted according to Equation (4). In the normal domain (i.e., not the bit-sliced domain), this operation is an extension of the bits of the operands, whereas, in the bit-sliced domain, this operation is an extension of the vectors of the operands. In lines 5 to 6, the operands are shuffled. As shown in Equation (3), the Hamming weight computations tolerate a randomization of the bit positions. In the bit-sliced domain, this corresponds to a shuffling of vector elements (words in the vector). In lines 7 to 13, the expanded operands x′[0:η−1] and y′[0:η−1] are randomly interchanged according to Equation (6) to further obfuscate the critical computations. In lines 12 and 13, a random rotation is applied as in Equation (8), which corresponds to a rotation of the coefficients in the non-bit-sliced domain.

In line 14, the critical non-linear Algorithm 6 BitAddTree is executed. It computes the Hamming weights of the operands and the binomially distributed samples according to Equation (1). At this point, the input operands are obfuscated.

The post-processing stage (lines 15 to 17) reverses the random rotation and bit-slicing. The sampled coefficients are returned in line 18.

FIG. 3, Algorithm 3: Algorithm 3 performs bit extraction and bit-slicing of the binomial sampling. The operands for the sampling (x[0:η−1] and y[0:η−1]) are extracted from a word array b[0:2η−1] and are transformed into the bit-sliced format. Algorithm 3 starts with an initialization of the output operands x[0:η−1] and y[0:η−1] (lines 1 and 2). In line 3, the word array b[0:2η−1] is converted into a bit string s, i.e., all words of b[0:2η−1] are concatenated to one large bit string. The output bits of x[0:η−1] and y[0:η−1] are extracted from s in a nested loop using Boolean arithmetic (lines 4 to 7). Each bit is packed into the respective location such that both output vectors are in the bit-sliced domain with η words, respectively. The output operands, in the bit-sliced domain, are returned in line 8.

FIG. 4, Algorithm 6: Algorithm 6 computes the critical non-linear operation of the sampling. It takes as input the operands x[0:η−1] and y[0:η−1], the output vector length λ and the binomial distribution parameter n. The algorithm supports extended and non-extended input operands. In line 1, an intermediate sum z[0: λ−1] is initialized. In line 2, the Hamming weight of x[0:η−1] is computed and added to this intermediate sum z[0: λ−1] using the function BitAdd according to Algorithm 5. In lines 3 and 4, this sum is added to the Hamming weight of y with another call of the function BitAdd. The resulting sum s[0: λ−1] equals to HW(x[0:η−1])+HW(y[0:η−1]) in bit-sliced format and is returned in line 5. It is noted that Algorithm 6 adds the two Hamming weights. Hence, the input operand y[0:η−1] is inverted and a correction by −η is applied to obtain a binomially distributed sample as discussed in section “Random swap of operands”.

FIG. 5, Algorithm 4: Algorithm 4 transforms the sum s[0: λ−1] of Algorithm 6 BitAddTree from the bit-sliced domain back to the normal domain and performs a post-processing step. The algorithm supports an extended as well as a non-extended input operand. In line 1, the output polynomial is initialized. In lines 2 to 4, the bit-slicing is reversed and the bits of the input vector s[0: λ−1] are iteratively shifted to the desired bit positions of the output coefficients in the normal domain. In lines 5 and 6, as a post-processing step, the constant n is subtracted from the coefficients to correct the offset discussed in section “Random swap of operands”.

FIG. 6, Algorithm 5: Algorithm 5 takes as input the bit-sliced word arrays z[0: λ−1] and x[0:η−1] and computes the bit-sliced sum s[0: λ−1]=z[0: λ−1]+HW(x[0:η−1]). In line 1, the sum s[0: λ−1] is initialized to zero. Lines 2 to 8 represent a typical ripple carry adder. The loop starts with the first bit-sliced word x[0] and adds it to z[0: λ−1], whereas the inner loop represents the carry chain. The intermediate result is then copied to z[0: λ−1] in line 8. The loop continues with the next words x[i] until all η words are processed and added to the intermediate sum. When the nested loops finished processing, the resulting sum is returned in line 9.

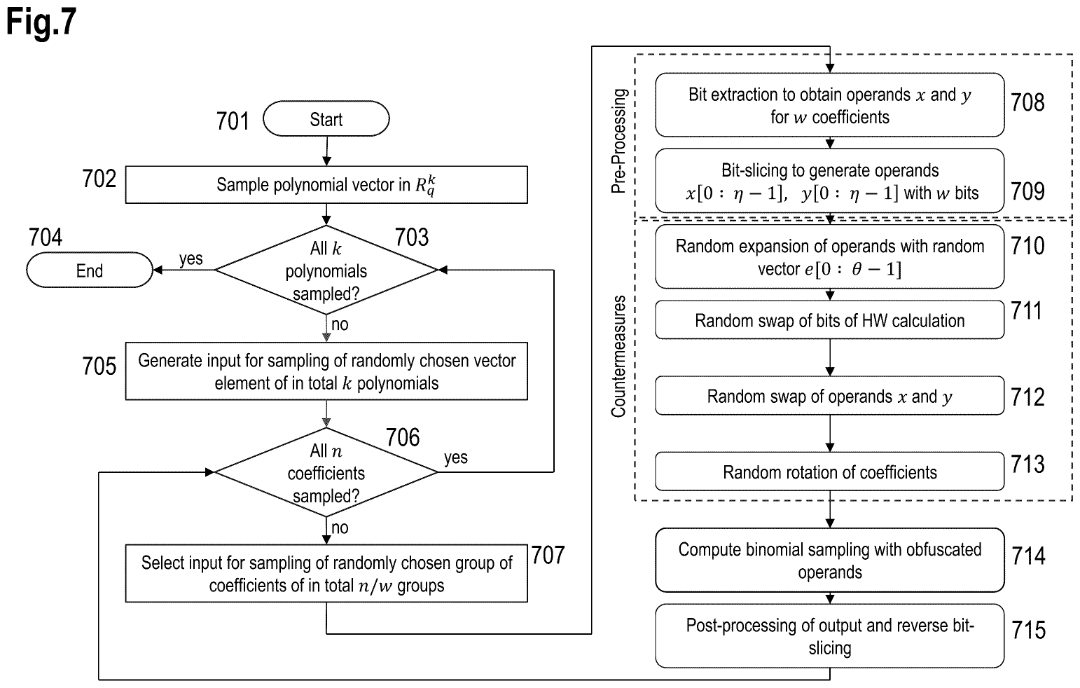

FIG. 7 shows an exemplary flow diagram visualizing the process of sampling countermeasures, as might be implemented in a cryptographic processing circuit, to thwart side-channel attacks on the processing circuit. After a start 701, a polynomial vector is sampled in [symbol] in a step 702. In a step 703, it is checked whether all k polynomials are sampled. If this is the case, it is branched to a step 704 and the process ends. If not, all k polynomials are sampled, it is branched to a step 705, in which the input values for the sampling of a randomly chosen polynomial of in total k polynomials is generated. In a subsequent step 706, it is determined whether all n coefficients are sampled. If this is the case, it is branched to step 703. If not, it is branched to a step 707. In step 707, input for sampling of randomly chosen group of coefficients of in total n/w groups is selected. It is noted that w is the word length also used for bit-slicing. Depending on the respective processor architecture, w may amount to, e.g., 32 or 64.

It is further noted that bit-slicing processes groups of w (e.g., 32) coefficients. A total of n coefficients thus results in a number of n/w groups. The chronological order of processing the groups can be chosen randomly (e.g., via shuffling), which leads to a random selection of the groups.

Next is a pre-processing stage comprising steps 708 and 709. In step 708, bit extraction is performed to obtain operands x and y for w coefficients. In the subsequent step 709, bit-slicing is performed to generate operands x[0:η−1] and y[0:η−1] each with w bits.

Countermeasures are described in subsequent steps 710 to 713. In step 710, a random expansion of the operands x[0:η−1] and y[0:η−1] with a random vector e [0: θ−1] is determined, respectively. In the next step 711, a random swap of the bit positions of the expanded input vectors is performed to randomize the bit-summation during the Hamming weight computations. As the operands are in bit-sliced domain, the swapping of the bit positions corresponds to a swap of the vector elements (words). Then, in step 712, the operands x and y are randomly swapped. In the subsequent step 713, the coefficients are randomly rotated. In the bit-sliced domain, this rotation corresponds to a bit-wise rotation of the words of the operands.

A subsequent step 714 comprises the critical operation of the computation of the binomial sampling. This critical operation is executed with the obfuscated operands.

In a next step 715, the output of step 714 is post-processed and the bit-slicing introduced in step 709 is reversed. Next, it is branched to step 706.

### Masked Version

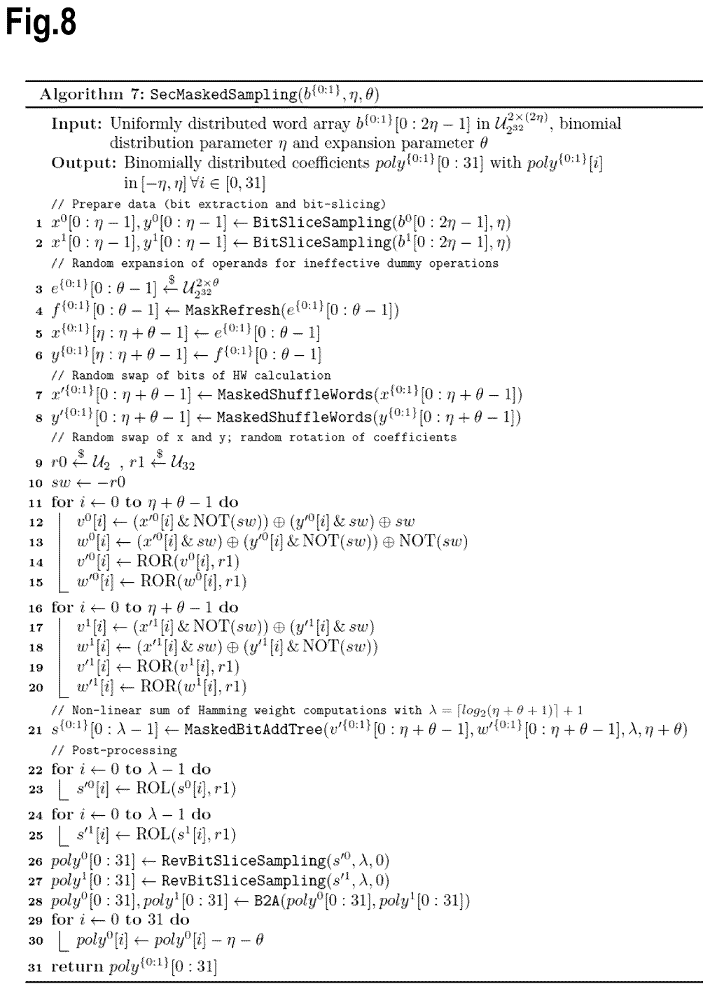

The masked version of Algorithm 2 is shown as an Algorithm 7 in FIG. 8 for two shares b^{{0:1}}. It is noted that most functions can be duplicated and executed on each share separately. Negations and additions/subtractions of constants can be performed on a single share.

Algorithm 7 is the masked version of the core algorithm for the secure sampling of w binomially distributed coefficients. In contrast to Algorithm 2, it performs all critical operations on randomized shares. Inputs are the Boolean shares b⁰[0:2η−1] and b¹[0:2η−1] generated using the function PRNG. The remaining input parameters are the same as in the non-masked version.

The algorithm starts with the bit extraction and bit slicing using the function BitSliceSampling in line 1 (for the first share) and in line 2 (for the second share).

In line 3, the two shares of the extension vector e^{{0:1}}[0: θ−1] are generated using a random source. In line 4, the masking of this extension vector is refreshed and assigned to f^{{0:1}}[0: θ−1] such that the plain/recombined value remains the same but the randomness in the sharing is different, i.e., e⁰⊕e¹=f₀ ⊕f¹. In lines 5 and 6, the operands are extended by the extension vectors.

In lines 7 and 8, the words of the extended operands are shuffled like in the non-masked version (Algorithm 2). Instead operating on plain values, this shuffling is happening on shares using a function MaskedShuffleWords, which is the masked version of the function ShuffleWords.

In lines 9 to 20, Algorithm 7 randomly swaps the operands and performs a random rotation of these operands, which corresponds to a random rotation of the coefficients in the normal (i.e., non-bit-sliced) domain. The randomness for these two operations is extracted in line 9. In line 10, the random bit that indicates a swap of the operands is transformed into a bit mask. More precisely, the value sw=0x00000000 indicates no swap and the value sw=OxFFFFFFFF indicates a swap (here, the word size w amounts to 32). The random rotation value is stored in r1. The actual random swap and rotation is performed in the loop of lines 11 to 15 for the first share of the operands and in the loop of lines 16 to 20 for the second share of the operands. The computations at the loop for the first share integrates the negation of one operand as in Equation (6).

In line 21, the critical non-linear function MaskedBitAddTree is performed. As in the non-masked version of Algorithm 2, the input operands are obfuscated at this point. The function works similar to the function BitAddTree. However, all operations are executed on shares.

At non-linear operations, such as the Boolean AND operation, the shares cannot be executed independently, i.e., the two shares are executed together in a single function. This can lead to accidental recombinations of the shares. Typically, extra randomness and particular attention at the masked implementation of non-linear functions are required.

In lines 22 to 27, the post-processing is applied. As in the non-masked version, the result of the non-linear operation is rotated back to the appropriate position and the bit-slicing is reversed. The correction discussed in section “Random swap of operands” is performed in lines 29 and 30 and not within the function RevBitSliceSampling. The reason is that a Boolean to arithmetic masking conversion according to function (B2A) is required before the subtraction of the constant. The function B2A transforms the Boolean sharing of poly^{{0:1}}[0:31] with poly⁰[0:31]⊕poly¹[0:31] into an arithmetic sharing with poly⁰[0:31]+poly¹[0:31]. After the masking conversion and correction, the result is returned in line 31.

### Further Examples and Advantages

The presented examples can be combined with a masking countermeasure.

Hamming weight computations tolerate a permutation of bit positions of the input operands.

The binomial sampling computation tolerates a random bit expansion of the two input operands if both operands are expanded with the same value. In a masked setting, the random value can be freshly shared for each operand. In combination with bit permutation, this leads to an effective obfuscation of the sampling computation.

Input operands can be efficiently swapped in a random fashion. The negation of the subtraction can be efficiently integrated during this swap.

A random rotation in bit-sliced format can be efficiently integrated leading to an increased attack complexity.

### Random Expansion of Operands

Embodiments refer to the random expansion of the sampling process, which corresponds to FIG. 7, step 710.

e is referred to as a random variable of θ bits that is used to expand the operand x. The expansion increases the operand size from η bits to η+θ bits. This can be a concatenation defined as

$${x}^{′} = x ‖ e .$$

With bit-operations this can also be expressed as

$$x ⋁ ( e ≪ η ) or x ⊕ ( e ≪ η ) .$$

Hence, either the OR-operation ‘V’ or the XOR-operation ‘⊕’ can be used. Such expansion can significantly increase the search space for an attacker. The Hamming weight computation without and with expansion can be computed as follows:

$$HW ( x ) = {\sum }_{i = 0}^{η - 1} {x}_{i} \qquad ( 9 )$$

$$HW ( {x}^{′} ) = {\sum }_{i = 0}^{η + θ - 1} {x}_{i}^{′} . \qquad ( 10 )$$

First Option: Random Expansion of Operands with Values of Same Hamming Weight

The following visualizes several steps of an exemplary expansion of operands x and y with two values that have the same Hamming weight (or have even the same value):
Step 1: Create a random value e with any value. Let θ be the number of bits for this value.
Step 2: Create a random value f with the same Hamming weight as e. Optionally, assign f=e. Let γ be the number of bits for this value.
Step 3: Extend the first operand x to x′=x∥e and the second operand y to y′=y∥f. The values x′ and y′ have η+θ and η+γ bits, respectively.
Step 4: Optionally, randomize the bit positions of x′. Optionally, randomize the bit positions of y′.
Step 5: Perform critical computation of sampling process with randomized operands x′ and y′.

Such random expansion results in the following equation:

$$SampleCoeff ( x , y ) = {\sum }_{i = 0}^{η - 1} {x}_{ShuffleIndex ( i )} - {\sum }_{j = 0}^{η - 1} {y}_{ShuffleIndex ( j )} mod q = {\sum }_{i = 0}^{η + θ - 1} {x}_{ShuffleIndex ( i )}^{′} - {\sum }_{j = 0}^{η + γ - 1} {y}_{ShuffleIndex ( j )}^{′} mod q , \qquad ( 11 )$$

wherein Shuffle Index indicates that the bit positions of the input operands can be randomly reordered (i.e., shuffled) as optionally shown in Step 4. As both operands are extended with a value of the same Hamming weight, the extension effectively cancels out during the computations of the sampling process. It is noted that sampling two random values with the same Hamming weight (Steps 1 and 2) can be realized according to the following:
i) Randomly generate the value e,
ii) Set f=e, and
iii) Optionally randomize the bit positions of f.

This process ensures HW(e)=HW(f).

Second Option: Random Expansion of Operands with Values of Different Hamming Weight

The following visualizes several steps of an exemplary expansion of operands x and y with two values that have different Hamming weights:
Step 1: Create a random value e with any value but known Hamming weight wₑ. Let θ be the number of bits for this value.
Step 2: Create a random value f with any value but known Hamming weight w_{f}. Let γ be the number of bits for this value.
Step 3: Extend the first operand x to x′=x∥e and the second operand y to y′=y∥f. The values x′ and y′ have η+θ and η+γ bits, respectively.
Step 4: Optionally, randomize the bit positions of x′. Optionally, randomize the bit positions of y′.
Step 5: Perform critical computation of sampling process with randomized operands x′ and y′.
Step 6: Add the offset w_{f}−wₑ to the sampling result.

Such random expansion results in the following equation:

$$SampleCoeff ( x , y ) + {w}_{e} - {w}_{f} = {\sum }_{i = 0}^{η + θ - 1} {x}_{ShuffleIndex ( i )}^{′} - {\sum }_{j = 0}^{η + γ - 1} {y}_{ShuffleIndex ( j )}^{′} mod q . \qquad ( 12 )$$

It is noted that sampling a random value with known Hamming weight (Steps 1 and 2) can be realized according to the following:
i) Initialize all θ/γ bits with zero,
ii) Set wₑ/w_{f} bits to logical ‘1’, and
iii) Optionally randomize the bit positions.

### Exemplary Implementations

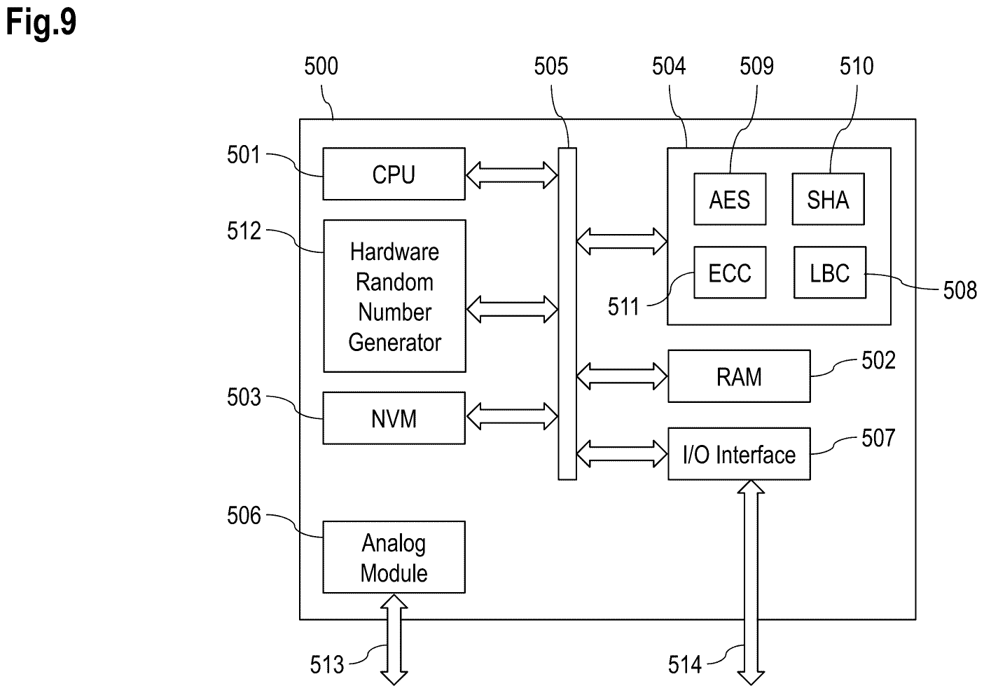

FIG. 9 shows a processing device 500 comprising a CPU 501, a RAM 502, a non-volatile memory 503 (NVM), a crypto module 504, an analog module 506, an input/output interface 507 and a hardware-random number generator 512. It is an option that other types of memory are provided, e.g., ROM.

In this example, the CPU 501 has access to at least one crypto module 504 over a shared bus 505 to which each crypto module 504 is coupled. Each crypto module 504 may in particular comprise one or more crypto cores to perform certain cryptographic operations. Exemplary crypto cores are:
an AES core 509 (AES: Advanced Encryption Standard),
a SHA core 510 (SHA: Secure Hash Algorithm),
an ECC core 511 (ECC: Elliptic Curve Cryptography), and
a lattice-based crypto core 508.

The CPU 501, the hardware random number generator 512, the NVM 503, the crypto module 504, the RAM 502 and the input/output interface 507 are connected to the bus 505. The input/output interface 507 may have a connection to other devices, which may be similar to the processing device 500.

The crypto module 504 may or may not be equipped with hardware-based security features.

The bus 505 itself may be masked or plain. Instructions to process the steps described herein may in particular be stored in the NVM 503 and processed by the CPU 501. The data processed may be stored in the NVM 503 or in the RAM 502. Supporting functions may be provided by the crypto modules 504 (e.g., expansion of pseudo random data).

Steps of the method described herein may exclusively or at least partially be conducted on the crypto module 504, e.g. on the lattice-based crypto core 508.

The processing device 500 may be a chip card powered by direct electrical contact or through an electro-magnetic field. The processing device 500 may be a fixed circuit or based on reconfigurable hardware (e.g., Field Programmable Gate Array, FPGA). The processing device 500 may be coupled to a personal computer, microcontroller, FPGA or a smart phone.

The solution described herein may be used by a customer that intends to provide a secure implementation of lattice-based cryptography on a smart card or any secure element.

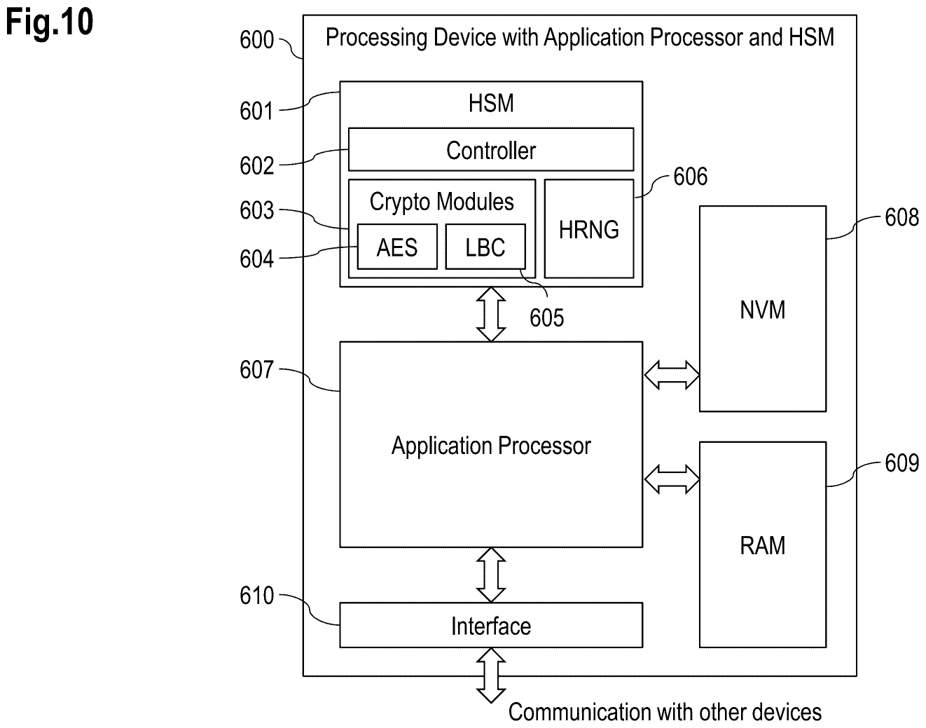

FIG. 10 shows another example of a processing device 600. The processing device 600 comprises a hardware security module 601, a non-volatile memory (NVM) 608, a random access memory (RAM) 609, an interface 610 for communication with other devices and an application processor 607, which is coupled with the hardware security module (HSM) 601, the RAM 609, the NVM 608 and the interface 610.

The HSM 601 comprises a controller 602, a hardware-random number generator (HRNG) 606 and at least one crypto module 603. The crypto module 603 exemplary comprises an AES core 604 and a lattice-based crypto (LBC) core 605.

According to one embodiment, the HSM 601 and the application processor 607 may be fabricated on the same physical chip with a tight coupling. The HSM 601 delivers cryptographic services and secured key storage while the application processor may perform computationally intensive tasks (e.g., image recognition, communication, motor control). The HSM 601 may be only accessible by a defined interface and considered independent of the rest of the system in a way that a security compromise of the application processor 607 has only limited impact on the security of the HSM 601. The HSM 601 may perform all tasks or a subset of tasks described with respect to the processing device 600 by using the controller 602, the LBC 605, supported by, exemplary, an AES 604 and the HRNG 606. It may execute the procedures described herein (at least partially) either controlled by an internal controller or as CMOS circuit. Moreover, also the application processor 607 may perform the procedures described herein (at least partially, e.g., in collaboration with the HSM 601).

The processing device 600 with this application processor 607 and HSM 601 may be used as a central communication gateway or (electric) motor control unit in cars or other vehicles, e.g., as advanced driver assistance system and/or connectivity device to other entities, e.g., cloud, cars, infrastructure, etc.

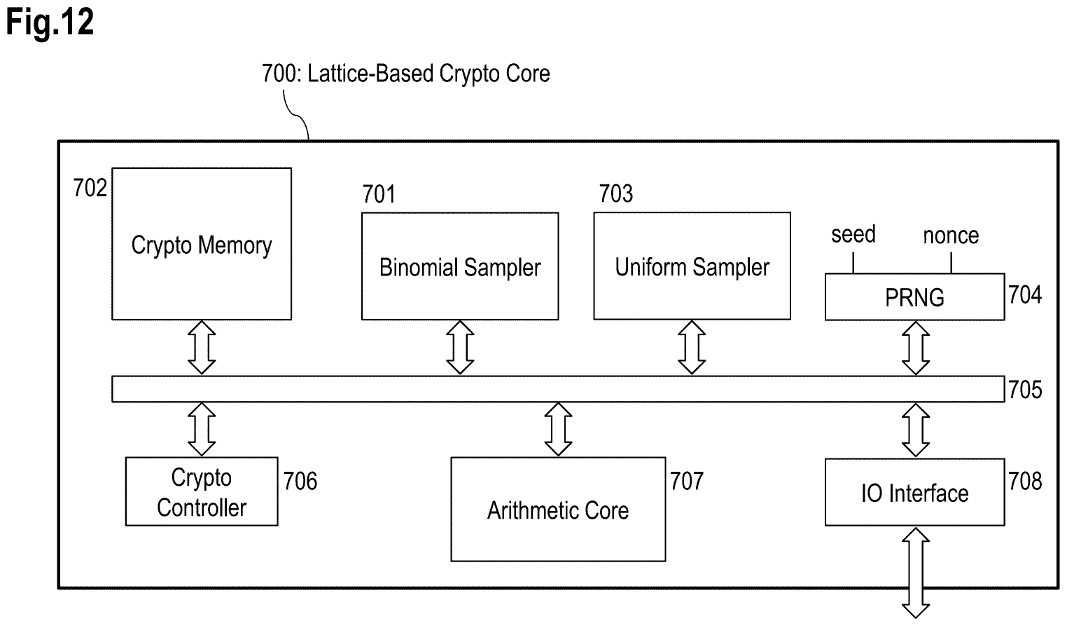

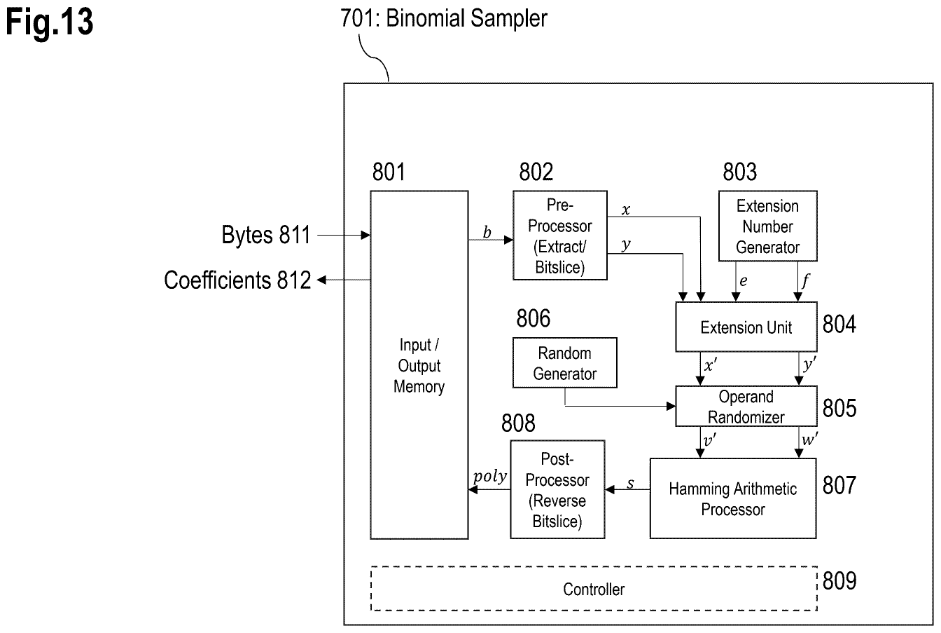

FIG. 12 shows a block diagram of an exemplary realization of a lattice-based crypto core 700, which can be used as the lattice-based crypto core 508 in FIG. 9 or the lattice-based crypto core 605 in FIG. 10.

In this exemplary realization, the lattice-based crypto core 700 comprises a bus 705 to which a binomial sampler 701, a crypto memory 702, a uniform sampler 703, a random generator 704, a crypto controller 706, an arithmetic core 707 and an input/output interface 708 are connected. The bus 705 enables communication between its connected components. The input/output interface 708 may have an interface that is connected to a component external to the lattice-based crypto core 700.

The random generator 704 may comprise hardware and/or software and it may provide random numbers or numbers approximating random numbers. The random generator 704 may be supplied (internally and/or externally) by at least one seed and/or by at least one nonce (i.e., a value that is only used once). The seed and nonce may have a predefined level of entropy and may be used to deterministically derive the (pseudo) random numbers. Alternatively, the random generator 704 may be implemented to supply true randomness.

FIG. 13 shows a schematic diagram of the binomial sampler 701 in greater detail. The binomial sampler 701 comprises a memory 801, a pre-processor 802, an extension number generator 803, an extension unit 804, an operand randomizer 805, a random generator 806, a Hamming arithmetic processor 807, a post-processor 808 and (optionally) a controller 809 (depicted in dashed lines).

It is noted that the blocks 801 to 809 may be regarded as functional entities that can be realized as separate physical entities or they may be combined to one or more (existing or additional) physical entities.

The memory 801 receives a set of bytes 811, which are processed by the binomial sampler 701 into coefficients 812 as follows: The pre-processor 802 reads the bytes 811, indicated as bytes b from the memory 801, extracts variables, conducts a transformation into the bit-slicing domain and supplies the operands x and y to the extension unit 804. The extension unit extends the operand x to x′ and the operand y to y′ based on values f and e generated by the extension number generator 803. Then, the operand randomizer 805 conducts a permutation based on numbers provided by the random generator 806 in order to obfuscate the operands x′ and y′ to v′ and w′. The Hamming arithmetic processor 807 conducts the critical operation based on the obfuscated operands v′ and w′ and provides a result s to the post-processor 808. The post-processor 808 conducts the inverse bit-slicing transformation and writes the resulting samples poly to the memory 801, which supplies the samples as coefficients 812.

The memory 801 may be realized as an input/output memory, e.g., a buffer. For example, the blocks 803 to 805 can be combined as a single block.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

1. A device for processing a lattice-based cryptographic operation, comprising:
a processing unit that is arranged to conduct a binomial sampling of coefficients comprising conducting a randomized expansion of binomial sampling operands utilizing a value e.

2. The device according to claim 1, wherein the value e is a random value ranging from zero up to 2^{θ}−1, wherein θ is an expansion parameter.

3. The device according to claim 2, wherein conducting the randomized expansion further comprises:
creating a random value f with the same Hamming weight as the value e, wherein γ is the number of bits of the random value f,
extending a first operand x of the binomial sampling operands to a value x′=x∥e and a second operand y of the binomial sampling operands to a value y′=y∥f, wherein the value x′ comprises η+θ bits and the value y′ comprises η+γ bits.

4. The device according to claim 3, wherein the processing unit is further arranged to perform a critical computation of the binomial sampling with the values x′ and y′.

5. The device according to claim 3, wherein the random value f equals the value e.

6. The device according to claim 3, wherein bit positions of the value x′ and/or bit positions of the value y′ are randomized.

7. The device according to claim 2, wherein conducting the randomized expansion further comprises:
creating the value e as a random value with a Hamming weight wₑ, wherein θ is the number of bits of the random value e,
creating a random value f with a Hamming weight w_{f}, wherein γ is the number of bits of the random value f,
extending a first operand x of the binomial sampling operands to a value x′=x∥e and a second operand y of the binomial sampling operands to y′=y∥f, wherein the value x′ comprises η+θ bits and the value y′ comprises η+γ bits.

8. The device according to claim 7, wherein the processing unit is further arranged to perform a critical computation of the binomial sampling with the values x′ and y′.

9. The device according to claim 8, wherein an offset is added to the result of the critical computation.

10. The device according to claim 9, wherein the offset amounts to w_{f}−wₑ.

11. The device according to claim 7, wherein bit positions of the value x′ and/or bit positions of the value y′ are randomized.

12. The device according to claim 1, wherein the randomized expansion is embedded within a bit-slicing transformation and a reverse bit-slicing transformation.

13. (canceled)

14. A method for processing a lattice-based cryptographic operation in a cryptographic processing circuit, the method comprising:
conducting a binomial sampling of coefficients, wherein a randomized expansion of binomial sampling operands is conducted utilizing a value e.

15. The method according to claim 14, wherein the value e is a random value ranging from zero up to 2^{θ}−1, wherein θ is an expansion parameter.

16. The method according to claim 15, wherein the randomized expansion of binomial sampling operands further comprises:
creating a random value f with the same Hamming weight as the value e, wherein γ is the number of bits of the random value f,
extending a first operand x of the binomial sampling operands to a value x′=x∥e and a second operand y of the binomial sampling operands to a value y′=y∥f, wherein the value x′ comprises η+θ bits and the value y′ comprises η+γ bits.

17. The method according to claim 16, wherein a critical computation of the binomial sampling is conducted utilizing the values x′ and y′.

18. The method according to claim 16, wherein the random value f equals the value e.

19. The method according to claim 16, wherein bit positions of the value x′ and/or bit positions of the value y′ are randomized.

20. The method according to claim 15, wherein the randomized expansion of binomial sampling operands further comprises:
creating the value e as a random value with a Hamming weight wₑ, wherein θ is the number of bits of the random value e,
creating a random value f with a Hamming weight w_{f}, wherein γ is the number of bits of the random value f,
extending a first operand x of the binomial sampling operands to a value x′=x∥e and a second operand y of the binomial sampling operands to y′=y∥f, wherein the value x′ comprises η+θ bits and the value y′ comprises η+γ bits.

21. The method according to claim 20, wherein a critical computation of the binomial sampling is conducted utilizing the values x′ and y′.

22. The method according to claim 21, wherein an offset is added to the result of the critical computation.

23. The method according to claim 22, wherein the offset amounts to w_{f}−wₑ.

24. The method according to claim 20, wherein bit positions of the value x′ and/or bit positions of the value y′ are randomized.

25. The method according to claim 14, wherein the randomized expansion is embedded within a bit-slicing transformation and a reverse bit-slicing transformation.

26. The device according to claim 1, wherein the device is at least one of the following or it is part of at least one of the following:
a security device,
a secured cloud,
a secured service,
an integrated circuit,
a hardware security module,
a trusted platform module,
a crypto unit,
an FPGA,
a processing unit,
a controller,
a smartcard.
